(19) United States
(12) Patent Application Publication
(10) Pub. No.: US 2022/0056278 A1
(43) Pub. Date: Feb. 24, 2022

(54) COLOR PAINTS TAILORED FOR SOLAR HEAT MANAGEMENT

(71) Applicants: John Michael HARDIN, Hopkinton, MA (US); M. Glenn HORNER, Roxbury, MA (US); Satish AGRAWAL, Sudbury, MA (US)

(72) Inventors: John Michael HARDIN, Hopkinton, MA (US); M. Glenn HORNER, Roxbury, MA (US); Satish AGRAWAL, Sudbury, MA (US)

(21) Appl. No.: 17/414,577

(22) PCT Filed: Dec. 17, 2019
(86) PCT No.: PCT/US2019/066792

§ 371 Date: Jun. 16, 2021

Related U.S. Application Data
(60) Provisional application No. 62/780,739, filed on Dec. 17, 2018.

(51) Int. Cl. C09D 5/33; C09D 7/62; C09D 7/40; C09D 7/41; C09D 175/04; C08G 18/73; C08G 18/62; C08K 9/02; C08K 5/01

(52) U.S. Cl. CPC C09D 5/004; C09D 7/62; C09D 7/70; C09D 7/69; C09D 7/41; C08K 2201/005; C08G 18/73; C08G 18/6279; C08K 9/02; C08K 5/01; C08K 2201/016; C09D 175/04

(57) ABSTRACT

This disclosure provides cool paints and paint systems tailored for solar heat management comprising (a) hydroxyl-containing fluorocarbon polymer as binder, (b) an effect pigment, and (c) an IR transparent pigment. Specifically, the dark color paints exhibit higher than 40% total solar reflectance (TSR) and excellent weathering properties e.g., maintaining at least 80% gloss after two-year of exposure to solar irradiation in field test.

### CROSS REFERENCE TO RELATED APPLICATION

This application claims the benefit of U.S. Provisional Patent Application No. 62/780,739, entitled “Colored Paints Tailored For Solar Heat Management,” filed Dec. 17, 2018, which is incorporated by reference herein in its entirety.

### FIELD OF THE INVENTION

This invention relates generally to the field of paints tailored for solar heat management that exhibit a desired color.

### BACKGROUND OF THE INVENTION

Roughly 50% of solar energy is absorbed at the Earth's surface. Rising energy costs, pronounced urban heat-island effects and global warming increase the need for intelligent solar heat management solutions like cool paints.

Cool paint refers to paint that lowers energy costs, generally air conditioning costs, by reflecting bands from the solar light spectrum that, when absorbed, contribute to solar heat load by increasing the temperature of the structure. Conventional cool paints were originally metallic coatings, such as aluminized coatings applied to both seal and reflect sun on metal structures. These aluminized coatings were effective in lowering air conditioning costs but are aesthetically unappealing due to high specular visible light reflection. In general, today conventional cool paints are bright white, produced by high loadings of titania, used primarily for low slope or flat roofs. The reflectance of the bright white cool paints can be a problem in some locations and applications.

Absorption of light in both the visible and infrared (IR) bands contributes to heat buildup in paints coated on a substrate. While white coatings (e.g., titania pigments) reflect broadly through the entire solar spectrum, colored paints will always have the solar reflectance reduced by the contribution of visible absorbance that produces the color. Color cool paints have been marketed in recent years, generally pastels, with a mixture of reflective pigments such as titanium dioxide (titania) and barium sulfate. These paints have been found to lose reflectivity quickly in areas with bright sun and heat. This is mostly due to the cracking of the paint on a microscopic level resulting from polymer degradation. The cracked paint absorbs dust and dirt, which counters the benefit of the reflective components. The loss of reflectivity of pastels is believed to be a result of UV absorption and subsequent photochemistry catalyzed by the titania pigments ubiquitous in these materials.

There are certain drawbacks associated with cool paints and cool paint systems comprising organic dark color pigments that are IR transparent (e.g., perylene pigments). One drawback has been difficulty in achieving coatings that exhibit a jet black color. This is because the infrared transparent organic pigments have a tendency to scatter light compared to the infrared-absorbing carbon black pigment. This problem is exacerbated in thin film areas and coating edges, where the coating may not appear black at all. Another drawback has been the inability to provide cool paints or cool paint systems that exhibit color “stability” in which the color of the coating does not change appreciably after exposure to weathering conditions.

As a result, it would be desirable to provide cool paints or cool paint systems tailored for solar energy management that are transparent to infrared radiation and can exhibit a “stable” color, such as a jet black, even in thin film areas and coating edges. It would also be desirable to provide paint or paint systems tailored for solar energy management with excellent weathering property, low IR radiation absorption and desired color matched with substrate.

### SUMMARY OF THE INVENTION

In some embodiments of the invention, this disclosure provides cool paints and cool paint systems tailored for solar heat management, specifically dark color cool paints that exhibit higher than 30% total solar reflectance (TSR) and excellent weathering properties, e.g., maintaining at least 80% gloss after two years of exposure to solar irradiation in a field test.

In some embodiments, this disclosure provides a paint or paint system for reflecting solar thermal energy comprising: a fluorocarbon polymer; an effect pigment; and an IR transparent pigment, wherein the effect pigment has a % reflectance that ranges from at least 10% at a wavelength of 750 nm to at least 50% at a wavelength of 900 nm, and wherein the IR transparent pigment has an average transmission of at least 65% in the near infrared wavelength region (700 nm-2600 nm).

In some embodiments, the fluorocarbon polymer is a prepolymer including an alternating copolymer comprising fluoroethylene and hydroxyl alkyl vinyl ether repeating units. In some embodiments, the paint or paint system further comprises an aliphatic polyisocyanate as crosslinker. In some embodiments, the aliphatic polyisocyanate is an oligomer or polymer of hexamethylene diisocyanate. In some embodiments, the fluorocarbon polymer is a crosslinked fluoropolyurethane. In some embodiments, the crosslinked fluoropolyurethane comprises an isocyanate. In some embodiments, the crosslinked fluoropolyurethane includes a reaction product of a fluoroethylene vinyl ether polyol with an aliphatic polyisocyanate. In some embodiments, the fluoroethylene vinyl ether polyol is an alternating copolymer comprising fluoroethylene and hydroxy alkyl vinyl ether as repeating units. In some embodiments, the aliphatic polyisocyanate is an oligomer or a polymer of hexamethylene diisocyanate.

In some embodiments, the fluoroethylene vinyl ether polyol has a hydroxyl value (OH number) in a range from about 10 mg KOH/g-polymer to about 200 mg KOH/g-polymer.

In some embodiments, the fluoroethylene vinyl ether polyol has a hydroxyl value (OH number) of about 100 mg KOH/g-polymer.

In some embodiments, this disclosure provides a paint or paint system comprising metallic aluminum pigment flakes as the effect pigment. In some embodiments, the metallic aluminum pigment flakes are in the form of thin flakes having a substantially flat structure. In some embodiments, the metallic aluminum pigment flakes have a thickness in a range selected from 0.05 μm to 10 μm, or 0.5 μm to 5 μm. In some embodiments, the metallic aluminum flakes have a maximum width in a range selected from 10 μm to 30 μm, or 10 μm to 150 μm. In some embodiments, the metallic aluminum flakes have a ratio of width to thickness in a range selected from: at least 2, 3 to 400, 10 to 2000, 10 to 200, or 10 to 150. In some embodiments, the metallic aluminum pigment flakes have a cornflake shape (angular edges and uneven surface), a silver dollar shape (rounded edges, smoother, fatter surface), or a disc shape. In some embodiments, the effect pigment comprises metallic pigment particles having an average median particle size distribution (D₅₀) range from 50 μm to 60 μm. In some embodiments, the effect pigment comprises a silicate coated metallic aluminum pigment.

In some embodiments, this disclosure provides a paint or paint system comprising an IR transparent pigment exhibiting color. In some embodiments, the IR transparent pigment exhibits a black color. In some embodiments, the IR transparent pigment comprises perylene black (Color Index Number 71133; Color Index Name perylene black 32). In some embodiments, the IR transparent pigment comprises one or more of copper phthalocyanine pigment, halogenated copper phthalocyanine pigment, anthraquinone pigment, quinacridone pigment, perylene pigment, monoazo pigment, disazo pigment, quinophthalone pigment, indanthrone pigment, dioxazine pigment, transparent iron oxide brown pigment, transparent iron oxide red pigment, transparent iron oxide yellow pigment, cadmium orange pigment, ultramarine blue pigment, cadmium yellow pigment, chrome yellow pigment, cobalt aluminate blue pigment, isoindoline pigment, diarylide yellow pigment, and brominated anthranthron pigment. In some embodiments, the paint or paint system is exclusive of titanium dioxide and barium sulfate.

In some embodiments, the paint or paint system has a total solar reflectance (TSR) of greater than 30%, or greater than 40% (standard solar irradiance at the Earth's surface corrected for atmospheric absorbance).

In some embodiments, the paint or paint system maintains at least 80% gloss retention upon exposure to QUV-A at 60° C. for 15,000 hours.

In one embodiment, this disclosure provides a paint system for reflecting solar thermal energy comprising: a base paint comprising: an epoxy, polyurethane, polyurea, or acrylic polymer; and an effect pigment; and a topcoat paint comprising: a fluorocarbon polymer; and an IR transparent pigment, wherein the effect pigment has a % reflectance that ranges from at least 10% at a wavelength of 750 nm to at least 50% at a wavelength of 900 nm, and wherein the IR transparent pigment has an average transmission of at least 65% in the near infrared wavelength region (700 nm-2600 nm).

In some embodiments, the fluorocarbon polymer is a prepolymer that comprises an alternating copolymer comprising fluoroethylene and hydroxyl alkyl vinyl ether repeating units.

In some embodiments, the paint system further comprises an aliphatic polyisocyanate crosslinker.

In some embodiments, the aliphatic polyisocyanate crosslinker is an oligomer or polymer of hexamethylene diisocyanate. In some embodiments, the fluorocarbon polymer is a crosslinked fluoropolyurethane. In some embodiments, the crosslinked fluoropolyurethane comprises an isocyanate cross linker. In some embodiments, the crosslinked fluoropolyurethane comprises a reaction product of a fluoroethylene vinyl ether polyol with an aliphatic polyisocyanate. In some embodiments, the fluoroethylene vinyl ether polyol is an alternating copolymer comprising fluoroethylene and hydroxy alkyl vinyl ether as repeating units. In some embodiments, the aliphatic polyisocyanate is hexamethylene diisocyanate. In some embodiments, the fluoroethylene vinyl ether polyol has a hydroxyl value (OH number) in a range from about 10 mg KOH/g-polymer to about 200 mg KOH/g-polymer. In some embodiments, the fluoroethylene vinyl ether polyol has a hydroxyl value (OH number) of about 100 mg KOH/g-polymer.

In some embodiments, the effect pigment in the paint system comprises metallic aluminum pigment flakes. In some embodiments, the metallic aluminum pigment flakes are in the form of thin flakes (substantially flat structure).

In some embodiments, the metallic aluminum pigment flakes have a thickness in a range selected from: 0.05 μm to 10 μm, or 0.5 μm to 5 μm. In some embodiments, the metallic aluminum pigment flakes have a maximum width in a range selected from 10 μm to 30 μm, or 10 μm to 150 μm. In some embodiments, the metal aluminum flakes have a ratio of width to thickness in a range selected from: at least 2, 3 to 400, 10 to 2000, 10 to 200, or 10 to 150. In some embodiments, the metal aluminum flakes have a cornflake shape (angular edges and uneven surface), silver dollar shape (rounded edges, smoother, flatter surface), or disc shape. In some embodiments, the effect pigment comprises metallic pigment particles having an average median particle size distribution (D₅₀) in a range from 50 μm to 60 μm. In some embodiments, the effect pigment comprises a silicate coated metallic aluminum pigment.

In some embodiments, the IR transparent pigment in the paint system is colored. In some embodiments, the IR transparent pigment exhibits black. In some embodiments, the IR transparent pigment comprises perylene black (Color Index Number 71133; Color Index Name perylene black 32). In some embodiments, the paint system is exclusive of titanium dioxide and barium sulfate, while in other embodiments the paint system includes titanium dioxide and/or barium sulfate.

In some embodiments, the paint system has a total solar reflectance (TSR) of greater than 30%, or greater than 40% (standard solar irradiance at the Earth's surface corrected for atmospheric absorbance). In some embodiments, the paint system exhibits excellent weatherability measured by 80% percent gloss retention by exposing the paint to QUV-A at 60° C. for 15,000 hours.

In one embodiment, this disclosure provides a method for reflecting solar thermal energy comprising: applying a paint to a substrate, wherein the paint comprises: a fluorocarbon prepolymer and a crosslinker; an effect pigment; and an IR transparent pigment; curing the paint to form crosslinking in the fluorocarbon polymer.

In one embodiment, this disclosure provides a method for reflecting solar thermal energy comprising: applying a base paint comprising a fluorocarbon prepolymer and a crosslinker and an effect pigment to a substrate; curing the base paint to form crosslinked fluorocarbon polymer; applying a topcoat paint comprising an IR transparent pigment to the base paint.
In an embodiment, this disclosure provides for an article including a substrate and a coating, wherein the coating is adhered to at least a portion of a surface of the substrate, and wherein the coating includes: a fluorocarbon polymer; an effect pigment having a % reflectance that ranges from at least 10% at a wavelength of 750 nm to at least 90% at a wavelength of 900 nm; and an IR transparent pigment having an average transmission of at least 70% in the near infrared wavelength region (700 nm-2600 nm). The substrate may be flexible or rigid. In some embodiments the substrate includes plastic. In some embodiments the substrate includes metal. In some embodiments the substrate includes one or more of stone, rock, brick, and ceramic. In some embodiments the surface of the substrate has been treated, for example to prevent corrosion or to promote adhesion, such as adhesion by a coating.

### DETAILED DESCRIPTION OF THE INVENTION

The present disclosure is based on the observations that reflection instead of absorption of solar energy by paints keeps the coated surface cool, and there are clear relationships between Total Solar Reflectance and heat build-up in any paint. This disclosure provides cool paints and cool paint systems that allow a metal roof to be painted with any color, including black, and still maintain high thermal reflectivity, as long as the pigment in the paints is infrared transparent. This disclosure provides cool paints and cool paint systems tailored for solar energy management comprising a crosslinked fluoropolymer binder to impart excellent weathering property and color “stability.” The paints based on crosslinked fluorocarbon polymer binder according to embodiments of the invention maximize the resistance to sun and the use environmental conditions, and maintain the low refractive index designed for optimal thermal reflection. The paints based on crosslinked fluorocarbon polymer binder according to embodiments of the invention do not crack in the sun and under the use environmental conditions such as exposure to oil, grease, heat, etc.

The solar electromagnetic spectrum that reaches the Earth's surface consists of about 3% of ultraviolet light (300-400 nm), about 42% of visible light (400-700 nm) and about 54% of infrared (IR) light (700-2600 nm). The energy radiated by the solar light hits the paint-coated substrate surface. When the radiation is absorbed by the paint, this generates heat, which is then transported by thermal conduction into a substrate material and by convection into the surrounding air. Less absorption of radiation means less heat build-up. The reflection from the coated substrate surface contributes to lower temperatures in the paint and also lower temperature strain in paint layers and for the substrates. This results in longer lifetime of the paint-coated substrate. The amount of total energy absorbed and emitted by a paint on a substrate determines the heat build-up of the paint-coated surface and results in a final surface temperature. The pigmentation of the paint is the main influence on the heat build-up performance. To achieve the cooling effect for a paint or paint system, the goal is to reflect infrared and absorb and reflect in the visible region to produce the needed color.

Black surfaces usually absorb up to 90% of this energy and therefore get hot. White surfaces, on the other hand, absorb only up to 25% and tend to stay much cooler. But white is not always an option; much more often color and especially dark shades are desired or even required. As a result, color paints having a dark color have historically been susceptible to substantially increased temperature, particularly on sunny days, which is often undesirable for many reasons. For example, an object like roof, a facade or the interior of a car, needs to have a certain color and therefore the pigment choice for the visible wavelength range is not free. To ensure the right color for the cool paint, the pigment or pigment combination with the right near infrared radiation (NIR) (700 nm-2600 nm) properties that matches the color of the object surface has to be chosen.

### Definitions

As used in the preceding sections and throughout the rest of this specification, unless defined otherwise, all technical and scientific terms used herein have the same meaning as is commonly understood by one of skill in the art to which this invention belongs. All patents and publications referred to herein are incorporated by reference in their entireties.

The term “scattering” as used herein, generally refers to the ability of pigment particles to turn the travel direction of light. Scattering depends on the refractive index of material, particle size and dispersion.

The term “absorption” as used herein, generally refers to the ability of pigment particles to attenuate the intensity of light. Pigments interact with solar radiation by absorption, reflection and scattering. Absorption is influenced by the structure of the pigment particles and the chemical composition of the pigment.

The term “color” as used herein, generally refers to reflected visible light perceived by the eye of the observer. Visible light is electromagnetic radiation with wavelength of 400-700 nm. Black absorbs all the light rays, whereas white reflects all light rays.

The term “color index” as used herein, generally refers to numbers given to pigments in the Color Index International.

The term “effect pigment” as used herein, generally refers to a pigment that, when included in a cool paint composition, provides a cured paint with a reflectance of infrared radiation (refers to light energy having a wavelength of from 700 to 2500 nanometers) greater than a cured paint deposited in the same manner from the same composition but without the infrared reflective pigment. The IR-reflective pigment exhibits reflectance of near infrared radiation (700 nm-2600 nm) and are also non-absorbing in the IR region.

The term “IR transparent pigment” as used herein, generally refers to a pigment that neither absorbs nor reflects light in the IR region of the solar light spectrum, e.g., a pigment that is substantially transparent in the near-infrared wavelength region (700 to 2600 nanometers).

The term “paint system” as used herein generally refers to a system of multiple layers of paint, e.g., a top coat and a base coat.

The term “total solar reflectance” (TSR) as used herein, generally refers to the pigment's reflection ability expressed as the percentage of irradiation energy that is reflected by an object. A TSR value of 100% means total reflection, and 0% means total absorption. For example, pigments with high TSR values show a high reflection combined with low heat build-up, and vice versa. Usually white paint exhibits a total solar reflectance of 75% or more. A black paint, based on carbon black pigmentation, may have a TSR as low as 4%, therefor absorbing 96% of the incident solar energy. For color cool paint, the higher the TSR parameter it has, the lower level of solar heat accumulation it will have.

The term “weathering characteristics” of a paint formed on a substrate as used herein, generally refers to the degradation and time behavior (surface crack, degree of degradation, percentage (%) of gloss retention, etc.) caused by the weathering conditions on the paint, such as exposure to sun and the indoor or outdoor environmental conditions of use (e.g., solar light exposure, rain, freeze, hot humid, hot dry, oil exposure, gas exposure, natural weathering conditions, etc.)

The “weathering characteristics” of a paint can be measured using a laboratory QUV test (an accelerated paint weathering effects test, e.g., exposure to QUV-A at 60° C. for 15,000 hours), or by an outdoor field test by subjecting the paint to the use environmental conditions for a prolonged period of time, for example, two years of exposure under the environmental conditions in Florida.

The QUV test measures accelerated weather conditions by exposing test paint samples to varying conditions of the most aggressive components of weathering: ultraviolet radiation, moisture and heat. A QUV test chamber uses fluorescent lamps to provide a radiation spectrum centered in the ultraviolet wavelengths. Moisture is provided by forced condensation, and temperature is controlled by heaters. The test samples are mounted in the QUV and subjected to a cycle of exposure to intense ultraviolet radiation followed by moisture exposure by condensation. Various cycles are defined depending upon the intended end use application—for example, a typical cycle for automotive exterior applications would be 8 hours UV exposure at 70° C. followed by 4 hours of condensation at 50° C. These cycles would be continued for extended periods of time—up to thousands of hours—simulating even longer periods of time in the real world.

### I. Paint Compositions for Solar Heat Management

In some embodiments, a paint composition comprises a polymer binder system, an effect pigment system, and optionally one or more additives. In some embodiments the polymer binder system includes a hydroxyl-containing fluorocarbon polymer. In some embodiments the effect pigment system includes an IR transparent pigment. In some embodiments, the cool paint composition comprises the hydroxyl-containing fluorocarbon polymer, the effect pigment, the IR transparent pigment being dispersed or dissolved, optionally together with the additives, in an organic and/or aqueous solvent or solvent mixture using methods conventionally known in the art.

In some embodiments, a paint composition has a total solar reflectance (TSR) of greater than 30%, or greater than 40% (standard solar irradiance at the earth's surface corrected for atmospheric absorbance). In some embodiments, the paint composition exhibits excellent weatherability measured by 80% percent gloss retention exposing the paint to QUV-A at 60° C. for 15,000 hours. In some embodiments, the paint composition exhibits excellent weatherability measured by 90% percent gloss retention exposing the paint to QUV-A at 60° C. for 15,000 hours.

A. Polymer Binder System

This disclosure provides cool paint formulations comprising a polymer binder system containing at least one crosslinked fluorocarbon polymer, or a mixture of crosslinkable hydroxyl-containing fluorocarbon copolymers, or a mixture of fluorocarbon and non-fluorocarbon polymers or copolymers and a crosslinker. In some embodiments, the cool paint formulations comprise a polymer binder system containing at least one crosslinkable fluoropolymer and a crosslinker, at least one “effects” pigment, and at least one IR transparent color pigments. In some embodiments, the cool paint composition comprises a polymer binder system containing a crosslinkable fluorocarbon polymer having plurality of reactive hydroxyl groups, at least one a crosslinker, at least one metallic aluminum pigment flake, and at least one infrared-transparent pigment. In some embodiments, the cool paint formulations comprise a polymer binder system containing at least one crosslinked fluorocarbon polymer. In some embodiments, the polymer binder system comprises a mixture of crosslinkable hydroxyl-containing fluoro-copolymers, polyester polyols, or polycarbonate polyols with crosslinkers.

### 1. Hydroxyl-Containing Fluorocarbon Copolymer

In some embodiments, the crosslinkable hydroxyl-containing fluorocarbon copolymer comprises fluoroethylene alkyl vinyl ether copolymer resins, known as FEVE resins. In some embodiments, the FEVE resins may comprise various repeating units such as (a) cyclohexyl vinyl ether, (b) fluoroolefin, (c) alkyl vinyl ether, and (d) hydroxyalkyl vinyl ether. By including the hydroxyl-containing fluorocarbon copolymer in the cool paint composition, the bulk hydrophobicity and acid resistance of the paint formed thereof are increased, thereby increasing the corrosion resistance of the paint. The hydroxyl-containing fluorocarbon copolymer binder in the paint imparts excellent weatherability, high adhesion strength, high toughness and corrosion resistance.

Inclusion of the hydroxyl-containing fluorocarbon copolymer causes the cool paint composition to form a three-dimensional polymer network. Specifically, the two or more reactive functional groups (e.g., hydroxyl groups) of the hydroxyl-containing fluorocarbon copolymer each react with a crosslinker to form the three-dimensional network structure. The rigidity of the three-dimensional polymer network formed with the hydroxyl-containing fluorocarbon copolymer affects the resiliency of a color paint formed from the cool paint composition.

In general, the greater crosslink density (which is directly related to the number of reactive functional groups (e.g., hydroxyl groups)) leads to greater rigidity, improved chemical and solvent resistance, and increased abrasion resistance. The resiliency of a cool paint formed from the cool paint composition is also influenced by the molecular weight, and size and type of the backbone of the hydroxyl-containing fluorocarbon copolymer and the crosslinker in the cool paint composition. For a given hydroxyl-containing fluorocarbon copolymer, increasing the molecular weight of the hydroxyl-containing fluorocarbon copolymer generally results in a compound that forms cool paints having greater resiliency as compared to the corresponding lower molecular weight hydroxyl-containing fluorocarbon copolymer.

In some embodiments, the crosslinkable hydroxyl-containing fluorocarbon copolymer may have a number average molecular weight of about 1,000 Da, to 50,000 Da. In some embodiments, the crosslinkable hydroxyl-containing fluorocarbon copolymer may have a number average molecular weight in a range from about 3,000 Da to about 30,000 Da. In some embodiments, the crosslinkable hydroxyl-containing fluorocarbon copolymer may have a number average molecular weight in a range from about 6,000 Da to about 16,000 Da. In some embodiments, the hydroxyl-containing fluorocarbon copolymer may have a number average molecular weight in a range from about 7,000 Da to about 8,000 Da. In some embodiments, the hydroxyl-containing fluorocarbon copolymer may have a number average molecular weight of about 6,000 Da, about 6,500 Da, about 7,000 Da, about 7,500 Da, about 8,000 Da, about 8,500 Da, about 9,000 Da, about 9,500 Da, about 10,000 Da, about 10,500 Da, about 11,000 Da, about 11,500 Da, about 12,000 Da, about 12,500 Da, about 13,000 Da, about 13,500 Da, about 14,000 Da, about 14,500 Da, about 15,000 Da, about 15,500 Da, or about 16,000 Da. In some embodiments, the hydroxyl-containing fluorocarbon copolymer has a number average molecular weight of about 7,000 Da.

In some embodiments, the hydroxyl-containing fluorocarbon copolymer has a hydroxyl value in a range from about 10.0 mg KOH/g-polymer to about 210.0 mg KOH/g-polymer. In some embodiments, the hydroxyl-containing fluorocarbon copolymer has a hydroxyl value range selected from: about 15.0 to about 205.0, about 20.0 to about 200.0, about 25.0 to about 195.0, about 30.0 to about 190.0, about 35.0 to about 185.0, about 40.0 to about 180.0, about 45.0 to about 175.0, about 50.0 to about 170.0, about 55.0 to about 165.0, about 60.0 to about 160.0, 65.0-155.0, about 70.0 to about 150.0, about 75.0 to about 145.0, about 80.0 to about 140.0, about 85.0 to about 135.0, about 90.0 to about 130.0, about 95.0 to about 125.0, about 100.0 to about 120.0, about 10.0 to about 50.0, about 50.0 to about 100.0, about 75.0 to about 125.0, about 80.0 to about 120.0, about 100.0 to about 150.0, or about 150.0 to about 210.0, wherein mg KOH/g-polymer as the unit applies to all numeric ranges. In some embodiments, the hydroxyl-containing fluorocarbon copolymer has a hydroxyl value selected from: about 10.0, about 15.0, about 20.0, about 25.0, about 30.0, about 35.0, about 40.0, about 45.0, about 50.0, about 52.0, about 55.0, about 57.0, about 60.0, about 65.0, about 70.0, about 75.0, about 80.0, about 85.0, about 90.0, about 95.0, about 100.0, about 105.0, about 110, about 115, about 120, about 125, about 130, about 135, about 140, about 145, about 150, about 155, about 160, about 165, about 170, about 175, about 180, about 185, about 190, about 195, about 200, about 205, or about 210, wherein mg KOH/g-polymer as the unit applies to all numeric ranges. In some embodiments, the hydroxyl-containing fluorocarbon copolymer has a hydroxyl value of greater than 80 mg KOH/g-polymer. In some embodiments, the hydroxyl-containing fluorocarbon copolymer has a hydroxyl value in a range from about 100.0 mg KOH/g-polymer to about 200 mg KOH/g-polymer. In some embodiments, the hydroxyl-containing fluorocarbon copolymer has a hydroxyl value of about 100 mg KOH/g-polymer. The hydroxyl-containing fluorocarbon copolymer having hydroxyl value of greater than 80 mg KOH/g-polymer can be used for the formation of a densely crosslinked fluorocarbon polymer network after being cured in the presence of crosslinker to form a paint surface having excellent abrasion resistance. The hydroxyl value can be measured in accordance with JIS K0070-1966.

Non-limiting examples of the hydroxyl-containing copolymer may include, but are not limited to various grades of copolymers of fluoroethylene and alkyl vinyl ether (FEVE) sold under trademark names including LUMIFLON® LF 100, LUMIFLON® LF 200 MEK (OH value, 50 mg KOH/g-polymer), LUMIFLON® LF 200F (OH value, 45 mg KOH/g-polymer), LUMIFLON® LF 200 (OH value, 52 mg KOH/g-polymer), LUMIFLON® LF 302, LUMIFLON® LF 400, LUMIFLON® LF 600, LUMIFLON® LF 600× (OH value, 57 mg KOH/g-polymer), LUMIFLON® LF 800, LUMIFLON® LF 906 N, LUMIFLON® LF 910N, LUMIFLON® LF 916 N, LUMIFLON® LF 936, LUMIFLON® LF 9010, LUMIFLON® LF 9716 (OH value, 170 mg KOH/g-polymer), LUMIFLON® LF 9721 (OH value, 160 mg KOH/g-polymer), LUMIFLON®-910LM (OH value, 100 mg KOH/g-polymer), LUMIFLON® LF 916F (OH value, 100 mg KOH/g-polymer, low molecular weight, high hydroxyl group content), and LUMIFLON® FD-1000 (OH value, 85 mg KOH/g-polymer). LUMIFLON® is a trademark owned by Asahi Glass Co., Ltd., Exton, Pa.

In some embodiments, the hydroxyl-containing fluorocarbon copolymer has a number average molecular weight in a range from about 6,000 Da to about 16,000 Da, a glass transition temperature (Tg) of about 48° C. to 62° C., and a hydroxyl number value in a range from about 40 mg KOH/g-polymer to about 110 mg KOH/g-polymer.

In some embodiments, the hydroxyl-containing fluorocarbon copolymer is LUMIFLON® LF 916F, which consists of fluoroethylene and alkyl vinyl ether segments (FEVE). The fluorinated segments provide outstanding UV stability, weather resistance, and chemical resistance, while the vinyl ether segments provide solvent compatibility and crosslinking sites. LUMIFLON® LF 916F prepolymer has a softening point of 117.5° C., a glass transition temperature (Tg) of 34° C., a number average molecular weight Mn=7,000 Da, high OH functionality, and an OH Number of 100 mg KOH/g-polymer.

The hydroxyl-containing fluorocarbon copolymer can be included in the cool paint composition in an amount in a range from about 2.5 wt. % to about 50.0 wt. % by the total weight of the paint composition. In some embodiments, the hydroxyl-containing fluorocarbon copolymer may be included in the cool paint composition in an amount in a range from about 2.5 wt. % to about 20 wt. %, from about 5 wt. % to about 17.5 wt. %, from about 8.0 wt. % to about 15 wt. %, or from about 15.0 wt. % to about 25.0 wt. % by the total weight of the paint composition. In some embodiments, the hydroxyl-containing fluorocarbon copolymer is present in an amount selected from: about 1.0 wt. %, about 1.5 wt. %, about 2.0 wt. %, about 2.5 wt. %, about 3.0 wt. %, about 3.5 wt. %, about 4.0 wt. %, about 4.5 wt. %, about 5.0 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, about 10.0 wt. %, about 10.5 wt. %, about 11.0 wt. %, about 11.5 wt. %, about 12.0 wt. %, about 12.5 wt. %, about 13.0 wt. %, about 13.5 wt. %, about 14.0 wt. %, about 14.5 wt. %, about 15.0 wt. %, about 15.5 wt. %, 16.0 wt. %, 16.5 wt. %, about 17.0 wt. %, about 17.5 wt. %, about 18.0 wt. %, about 18.5 wt. %, about 19.0 wt. %, about 19.5 wt. %, about 20.0 wt. %, about 20.5 wt. %, about 21.0 wt. %, about 21.5 wt. %, about 22.0 wt. %, about 22.5 wt. %, about 23.0 wt. %, about 23.5 wt. %, about 24.0 wt. %, about 24.5 wt. %, about 25.0 wt. %, about 25.5 wt. %, about 26.0 wt. %, about 26.5 wt. %, about 27.0 wt. %, about 27.5 wt. %, about 28.5 wt. %, about 29.0 wt. %, about 29.5 wt. %, about 30.0 wt. %, about 30.5 wt. %, about 31.0 wt. %, about 32.0 wt. %, about 32.5 wt. %, about 33.0 wt. %, about 33.5 wt. %, about 34.0 wt. %, about 34.5 wt. %, about 35.0 wt. %, about 35.5 wt. %, about 36.0 wt. %, about 36.5 wt. %, about 37.0 wt. %, about 37.5 wt. %, about 38.0 wt. %, about 38.5 wt. %, about 39.0 wt. %, about 39.5 wt. %, about 40.0 wt. %, about 40.5 wt. %, about 41.0 wt. %, about 41.5 wt. %, about 42.0 wt. %, about 42.5 wt. %, about 43.0 wt. %, about 43.5 wt. %, about 44.0 wt. %, about 44.5%, about 45.0 wt. %, about 45.5 wt. %, about 46.0 wt. %, about 46.5 wt. %, about 47.0 wt. %, about 47.5 wt. %, about 48.0 wt. %, about 48.5 wt. %, about 49.0 wt. %, about 49.5 wt. %, or about 50.0 wt. % by the total weight of the paint composition.

The hydroxyl-containing fluorocarbon copolymer can be included in the cool paint composition in an amount in a range from about 10.0 wt. % to about 60.0 wt. % by the total solids weight of the paint composition. In some embodiments, the hydroxyl-containing fluorocarbon copolymer may be included in the cool paint composition in an amount in a range from about 20 wt. % to about 50 wt. %, from about 25.0 wt. % to about 45.0 wt. %, from about 25.0 wt. % to about 35.0 wt. %, from about 35.0 wt. % to about 45.0 wt. %, or from about 30.0 wt. % to about 40.0 wt. % by the total solids weight of the paint composition. In some embodiments, the hydroxyl-containing fluorocarbon copolymer is present in an amount selected from: about 1.0 wt. %, about 1.5 wt. %, about 2.0 wt. %, about 2.5 wt. %, about 3.0 wt. %, about 3.5 wt. %, about 4.0 wt. %, about 4.5 wt. %, about 5.0 wt. %, about 5.5 wt. %, about 6.0 wt. %, about 6.5 wt. %, about 7.0 wt. %, about 7.5 wt. %, about 8.0 wt. %, about 8.5 wt. %, about 9.0 wt. %, about 9.5 wt. %, about 10.0 wt. %, about 10.5 wt. %, about 11.0 wt. %, about 11.5 wt. %, about 12.0 wt. %, about 12.5 wt. %, about 13.0 wt. %, about 13.5 wt. %, about 14.0 wt. %, about 14.5 wt. %, about 15.0 wt. %, about 15.5 wt. %, 16.0 wt. %, 16.5 wt. %, about 17.0 wt. %, about 17.5 wt. %, about 18.0 wt. %, about 18.5 wt. %, about 19.0 wt. %, about 19.5 wt. %, about 20.0 wt. %, about 20.5 wt. %, about 21.0 wt. %, about 21.5 wt. %, about 22.0 wt. %, about 22.5 wt. %, about 23.0 wt. %, about 23.5 wt. %, about 24.0 wt. %, about 24.5 wt. %, about 25.0 wt. %, about 25.5 wt. %, about 26.0 wt. %, about 26.5 wt. %, about 27.0 wt. %, about 27.5 wt. %, about 28.5 wt. %, about 29.0 wt. %, about 29.5 wt. %, about 30.0 wt. %, about 30.5 wt. %, about 31.0 wt. %, about 32.0 wt. %, about 32.5 wt. %, about 33.0 wt. %, about 33.5 wt. %, about 34.0 wt. %, about 34.5 wt. %, about 35.0 wt. %, about 35.5 wt. %, about 36.0 wt. %, about 36.5 wt. %, about 37.0 wt. %, about 37.5 wt. %, about 38.0 wt. %, about 38.5 wt. %, about 39.0 wt. %, about 39.5 wt. %, about 40.0 wt. %, about 40.5 wt. %, about 41.0 wt. %, about 41.5 wt. %, about 42.0 wt. %, about 42.5 wt. %, about 43.0 wt. %, about 43.5 wt. %, about 44.0 wt. %, about 44.5%, about 45.0 wt. %, about 45.5 wt. %, about 46.0 wt. %, about 46.5 wt. %, about 47.0 wt. %, about 47.5 wt. %, about 48.0 wt. %, about 48.5 wt. %, about 49.0 wt. %, about 49.5 wt. %, or about 50.0 wt. % by the total solids weight of the paint composition.

### 2. Polyester Polyol and Polycarbonate Binder

In some embodiments, the binder of the cool paint comprises a crosslinkable polyester polyol binder (a hydroxyl-containing polyester resin). In some embodiments the binder comprises (i) a hydroxyl-containing polyester resin; and (ii) a hydroxyl-containing fluorocarbon copolymer resin. While not required in all embodiments, when included the polyester polyol binder may impart excellent mechanical properties to the cool paint, including flexibility, heat resistance and/or hardness. In some embodiments, the hydroxyl containing polyester comprises the reaction product of a polyhydric alcohol and a polycarboxylic compound selected from the group consisting of polycarboxylic acids, polycarboxylic acid anhydrides, polycarboxylic acid esters, and combinations thereof. In some embodiments the polycarboxylic compounds are selected from the group consisting of adipic acid, sebacic acid, azelaic acid, dodecanedioic acid, glutaric anhydride, maleic anhydride, fumaric acid, dimerized and trimerized unsaturated fatty acids, terephthalic acid dimethyl ester, terephthalic acid bis-glycol ester, and combinations thereof. In some embodiments, the polyhydric alcohol is selected from the group consisting of ethylene glycol, 1,2 propanediol, 1,3-propanediol, 1,4-butanediol, 2,3-butanediol, 1,6-hexanediol, 1,10-decanediol, 1,4-bis(hydroxymethyl)cyclohexane, 2-methyl-1,3-propanediol, glycerol, 1,2,6-hexanetriol, di-ethylene glycol, tri-ethylene glycol, tetraethylene glycol, propylene glycol, and pentaerythritol, mannitol, sorbitol, and combinations thereof.

In some embodiments, the crosslinkable polyester polyol has a number average molecular weight of 250 Da to 30,000 Da. In some embodiments, the crosslinkable polyester polyol has a number average molecular weight in a range from 1,000 Da to 10,000 Da. In some embodiments, the crosslinkable polyester polyol has a number average molecular weight range selected from: 250 Da to 5,000 Da, 250 Da to 50,000 Da, 250 Da to 100,000 Da, 250 Da to 250,000 Da, or 250 Da to 500,000 Da. In some embodiments, the crosslinkable polyester polyol has a number average molecular weight selected from: about 250, about 300, about 350, about 400, about 450, about 500, about 550, about 600, about 650, about 700, about 750, about 800, about 850, about 900, about 950, about 1000, about 1050, about 1100, about 1150, about 1200, about 1250, about 1300, about 1350, about 1400, about 1450, about 1500, about 1600, about 1650, about 1700, about 1750, about 1800, about 1850, about 1900, about 1950, about 2000, about 2050, about 2100, about 2150, about 2200, about 2250, about 2300, about 2350, about 2400, about 2450, about 2500, about 2550, about 2600, about 2650, about 2700, about 2750, about 2800, about 2850, about 2900, about 2950, about 3000, about 3050, about 3100, about 3150, about 3200, about 3250, about 3300, about 3350, about 3400, about 3450, about 3500, about 3550, about 3600, about 3650, about 3700, about 3750, about 3800, about 3850, about 3900, about 3950, about 4000, about 4050, about 4100, about 4150, about 4200, about 4250, about 4300, about 4350, about 4400, about 4450, about 4500, about 4550, about 4600, about 4650, about 4700, about 4750, about 4800, about 4850, about 4900, about 4950, about 5000, about 5100, about 5200, about 5300, about 5400, about 5500, about 5600, about 5700, about 5800, about 5900, about 6000, about 6100, about 6200, about 6300, about 6400, about 6500, about 6600, about 6700, about 6800, about 6900, about 7000, about 7100, about 7200, about 7300, about 7400, about 7500, about 7600, about 7700, about 7800, about 7900, about 8000, about 8100, about 8200, about 8300, about 8400, about 8500, about 8600, about 8700, about 8800, about 8900, about 9000, about 9100, about 9200, about 9300, about 9400, about 9500, about 9600, about 9700, about 9800, about 9900, about 10,000, about 25,000, about 50,000, about 75,000, about 100,000, about 150,000, about 200,000, about 250,000, about 300,000, about 350,000, about 400,000, about 450,000, about 500,000, about 550,000, about 600,000, about 650,000, about 700,000, or about 750,000, wherein Da is the unit that applies to all numeric numbers.

In some embodiments, the crosslinkable polyester polyol has an OH number of from about 20 mg KOH/g-polymer to about 200 mg KOH/g-polymer. The hydroxyl number (OH number) indicates the mg of potassium hydroxide equivalent to the amount of acetic acid which is bound by 1 g of substance upon acetylation of free hydroxyls in the substance. In some embodiments, the crosslinkable polyester polyol has an OH number in a range from about 20 mg KOH/g-polymer to about 30 mg KOH/g-polymer. In some embodiments, the crosslinkable polyester polyol has an OH number of about 50 mg KOH/g-polymer. In some embodiments, the crosslinkable polyester polyol has an OH number value selected from: about 2, about 5, about 10, about 20, about 30, about 35, about 40, about 45, about 50, about 55, about 60, about 65, about 70, about 75, about 80, about 85, about 90, about 95, about 100, about 105, about 110, about 115, about 120, about 125, about 130, about 135, about 140, about 145, about 150, about 155, about 160, about 165, about 170, about 175, about 180, about 185, about 190, about 195, about 200, about 210, about 220 about 230, about 240, about 250, about 260, about 270, about 280, about 290, about 300, wherein mg KOH/g-polymer as the units applies to all numeric values.

In some embodiments, the crosslinkable polyester polyol has a number average molecular weight in a range from about 4000 Da to about 20000 Da, a Tg of about 48° C. to 80° C., and a hydroxyl number in a range from about 100 mg KOH/g-polymer to about 350 mg KOH/g-polymer. The polyester polyol resins may comprise hydroxyl-terminated hyperbranched polyester resins. In some embodiments, the crosslinkable polyester polyol having an average molecular weight in a range from about 13,000 Da to about 17,000 Da, a Tg of about 48° C. to 62° C., and a hydroxyl number in a range from about 90 mg KOH/g-polymer to about 350 mg KOH/g-polymer.

In some embodiments, the weight ratio for the hydroxyl-containing polyester resin to the hydroxyl-containing fluorocarbon copolymer resin is 1:4, 1:3, 1:2, 1:1, 2:1, 3:1 or 4:1. In some embodiments, the weight ratio for the hydroxyl-containing polyester resin to the hydroxyl-containing fluorocarbon copolymer resin is 1:1. In some embodiments, the binder of the cool paint comprises (i) a hydroxyl-containing polyester resin having a hydroxyl number of at least about 100; and (ii) a hydroxyl-containing fluorocarbon copolymer resin with a hydroxyl number of about 40 to about 60; wherein weight ratio of the hydroxyl-containing polyester resin to the hydroxyl-containing fluorocarbon copolymer resin is of about 1:4 to 4:1.

In some embodiments, the binder of the cool paint comprises a crosslinkable polycarbonate polyol. In some embodiments, the polycarbonate polymer chain ends terminate with hydroxyl groups. Such hydroxyl groups serve as reactive moieties for cross-linking reactions. In some embodiments, the polycarbonate polyol is the condensation product between a polyhydric alcohol and a carbonate ester. In some embodiments, the carbonate ester may include ethylene carbonate, 1,2- or 1,3-propylene carbonate, diethyl or dibutyl carbonate. In some embodiments, the polycarbonate polyols may be poly(propylene carbonate) (PPC); poly(ethylene carbonate) (PEC); poly(butylene carbonate) (PBC); and poly(cyclohexene carbonate) (PCHC) as well as copolymers of two or more of these. In some embodiments, the polyhydric alcohol may be diols such as ethylene glycol, propylene glycol, 1,4-butanediol, 1,5-pentanediol, 1,6-hexanediol; alkoxylated phenolic compounds, such as ethoxylated or propoxylated bisphenols, cyclohexanedimethanol; or polyols such as glycerol, neopentyl glycol, pentaerythritol, glycerol, sorbitol, mannitol.

In some embodiments, the polycarbonate polyols have at least 98% or in some cases greater than 99% of chain ends terminate in hydroxyl groups. In some embodiments, the polycarbonate polyols have average molecular weight numbers is in a range from about 500 Da to about 15,000 Da. In some embodiments, the polycarbonate polyols have a polydispersity index (PDI) less than about 2. In some embodiments, the polycarbonate polyols have a PDI less than 1.2.

In some embodiments, the paint containing hydroxyl-containing fluorocarbon copolymer as binder exhibits excellent weatherability as measured by 80% percent gloss retention by exposing the paint to QUV-A test at 60° C. for 15,000 hours (an accelerated weathering condition, standard practice for light/water exposure of paint). In some embodiments, the paint containing hydroxyl-containing fluorocarbon copolymer as binder exhibits excellent weatherability as measured by 90% percent gloss retention by exposing the paint to QUV-A test at 60° C. for 15,000 hours.

In some embodiments, the paint containing the hydroxyl-containing fluorocarbon copolymer exhibits excellent weatherability as measured by the gloss retention after exposing the paint to the weathering conditions in Florida (field testing site) for two years.

### 3. Crosslinker

In some embodiments, the cool paint composition comprises a crosslinking agent (also known as crosslinker). In some embodiments, the crosslinker comprises isocyanates (containing reactive NCO group). Examples of the isocyanate compounds include a polyvalent isocyanate compound, which cures a hydroxyl-containing fluorocarbon copolymer; and a block-type isocyanate compound, in which the reactive NCO group on the polyvalent isocyanate compound is protected with a blocking agent so as not to proceed to a crosslink reaction at room temperature.

The polyvalent isocyanate compound is a compound having two or more isocyanate groups, and may be a modified product or multimer having two or more reactive isocyanate groups. Examples of the polyvalent isocyanate compounds include, but are not limited to: an aliphatic polyvalent isocyanate compound, such as ethylene diisocyanate, propylene diisocyanate, tetramethylene diisocyanate, hexamethylene diisocyanate, hexamethylene triisocyanate, and lisyne diisocyanate; an alicyclic polyvalent isocyanate compound, such as isophorone diisocyanate, dicyclohexyl methane diisocyanate, and diisocyanate methyl cyclohexane; and a non-yellowing aromatic isocyanate compound, such as m-xylene diisocyanate, and p-xylene diisocyanate

In some embodiments, the crosslinker comprises aliphatic polyisocyanates. In some embodiments, the aliphatic polyisocyanate comprises a branched or linear alkylene chain linking the isocyanate groups. In some embodiments the alkylene chain generally has 4 to 10 carbons.

In some embodiments, the aliphatic polyisocyanates may include hexamethylene diisocyanate (HDI) trimer, hexamethylene diisocyanate (HDI) condensing diurea, hexamethylene diisocyanate (HDI) adducts, isophorone diisocyanate trimer, isophorone diisocyanate (IPDI) adduct. In some embodiments, the aliphatic polyisocyanates are selected from tetramethylene diisocyanate, hexamethylene diisocyanate (HDI), isophorone diisocyanate (IPDI), 2-methylpentane (MPDI), 2,2,4-trimethylhexamethylene diisocyanate/2,4,4-trimethylhexamethylene diisocyanate (TMDI), 2-methyl-1,5-diisocyanate, pentane-1,4-diisocyanate, hexane-1,5-diisocyanate, trimethyl-1,6-diisocyanate, or a combination or sub-combination thereof.

In some embodiments, the aliphatic polyisocyanate comprises an oligomer or polymer of hexamethylene diisocyanate, for example, a polyisocyanate having the formula (I):

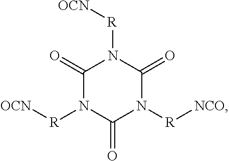

wherein R is a divalent hydrocarbon group selected from C4-C10 alkylene, or C5-C8 cyclic alkylene. In some embodiments, the crosslinker is hexamethylene diisocyanate homopolymers, where R is C6 alkylene in formula (I) (i.e., “DESMODUR® N-3300” sold by Bayer Corp.).

Some of the commercially available polyisocyanates include “DESMODUR® N-100”, “DESMODUR® 3200”, and “DESMODUR® N-3300” that are hexamethylene diisocyanate homopolymers commercially available from the Bayer Corporation. “DESMODUR® N-3300” is a hexamethylene diisocyanate-derived isocyanurate trimer which can be represented by the formula (II):

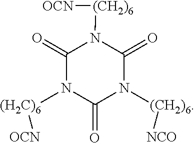

In some embodiments, the amount of the crosslinker is adjusted such that the molar ratio between the OH-groups of the binder mixture, i.e., in particular the OH groups of the hydroxy-functional fluoropolymer, and the NCO groups of the polyisocyanate is in the range of 0.1:1 to 3.0:1, preferably, 0.5:1 to 1.5:1, preferably 0.8:1 to 1.2:1, and more preferably 0.9:1 to 1.1:1. In some embodiments, the molar ratio of OH-groups of hydroxyl-containing fluorocarbon copolymer to NCO groups of the polyisocyanate is 0.1:1, 0.2:1, 0.3:1, 0.4:1, 0.5:1, 0.6:1, 0.7:1, 0.8:1, 0.9:1, 1:1, 1.1:1, 1.2:1, 1.3:1, 1.4:1, 1.5:1, 1.6:1, 1.7:1, 1.8:1, 1.9:1, 2.0:1, 2.5:1, or 3.0:1. The above ratio ranges are applicable in particular to the hexamethylene diisocyanate homopolymers as polyisocyanate.

### 4. Binder-Curing Catalyst

In some embodiments, the cool paint composition may optionally comprise an organic metal catalyst to promote the crosslinking reaction between the NCO group of isocyanate crosslinker and the OH group of the hydroxyl-containing binder polyol prepolymer (fluorocarbon polymer and/or polyester). In some embodiments, the organic metal catalysts may include one or more of stannous octoate, dibutyltindilaurate (DBTL), and zirconium chelate complex. The organic metal catalysts act as Lewis acids and, without being bound by theory, are thought to function by forming an intermediate complex with an isocyanate group and a polyol hydroxyl group.

In some embodiments, the organic metal catalyst is zirconium chelate complex, for example, K-kat® 4205 (urethane curing catalyst sold by King Industries). In some embodiments, the organic metal catalyst is used in an amount of about 0.1-5.0 wt. % by the total weight of the cool paint composition. In some embodiments, the organic catalyst is presented in an amount ranging from about 0.75 wt. % to about 3.0 wt. % by the total weight of the cool paint composition. In some embodiments, the organic catalyst is presented in an amount ranging from about 0.5 wt. % to about 2.0 wt. % by the total weight of the cool paint composition. In some embodiments, the organic catalyst is presented in an amount ranging from about 0.75 wt. % to about 1.0 wt. % by the total weight of the cool paint composition. In some embodiments, the organic catalyst is presented in an amount selected from: about 0.1, about 0.25 wt. %, about 0.5 wt. %, about 0.75 wt. %, about 1.0 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2.0 wt. %, about 2.1 wt. %, about 2.2 wt. %, about 2.3 wt. %, about 2.4 wt. %, about 2.5 wt. %, about 2.75 wt. %, about 3.0 wt. %, about 3.25 wt. %, about 3.5 wt. %, about 3.75 wt. %, about 4.0 wt. 5, about 4.25 wt. %, about 4.5 wt. %, about 4.75 wt. %, or 5.0 wt. % by the total weight of the cool paint composition.

B. Pigment System

### 1. Effect Pigment

In some embodiments, the cool paint composition comprises at least one effect pigment. The presence of the effect pigment may have a significant influence on the TSR value in connection with an organic IR transparent pigment. For example, an increased amount of TiO₂ coated mica pigment increases the TSR value of a cool paint composition comprising an organic IR transparent pigment.

The effect pigment can be colored or essentially colorless, translucent or opaque. As used herein, the term “essentially colorless” means that the pigment does not have a color, i.e., the absorption curve for the pigment is devoid of absorption peaks in the 400-700 nanometer range and does not present a tint or hue in reflected or transmitted light when viewed under sunlight. A color effect pigment is an effect pigment that may be visibly absorbing and reflecting in the visible region of the electromagnetic spectrum (400 nm-700 nm). A “translucent” pigment means that visible light is able to pass through the pigment diffusely. An “opaque” pigment is one that is not translucent. One example of an effect pigment that can be translucent and essentially colorless is SOLARFLAIR® 9870 pigment (sold by Merck KGaA of Darmstadt, Germany, an interference pigment that comprises a mica substrate that is coated with titanium dioxide).

In some embodiments, the effect pigment exhibits a color. Suitable effect pigments may include any of a variety of metals and metal alloys, inorganic oxides, and interference pigments; titanium dioxide (white); iron titanium brown spinel (brown); chromium oxide (green); iron oxide (red); chrome titanate and nickel titanate (yellow); TiO₂ coated mica flakes (blue and violet).

In some embodiments, the effect pigment is a metal or a metal alloy effect pigment. In some embodiments, the metals and metal alloy effect pigments may include, aluminum, chromium, cobalt, iron, copper, manganese, nickel, silver, gold, iron, tin, zinc, bronze, brass, alloys thereof (e.g. zinc-copper alloys, zinc-tin alloys, and zinc-aluminum alloys). In some embodiments, the metal alloy effect pigments may include nickel antimony titanium, nickel niobium titanium, chrome antimony titanium, chrome niobium, chrome tungsten titanium, chrome iron nickel, chromium iron oxide, chromium oxide, chrome titanate, manganese antimony titanium, manganese ferrite, chromium green-black, cobalt titanates, chromites, or phosphates, cobalt magnesium, and aluminites, iron oxide, iron cobalt ferrite, iron titanium, zinc ferrite, zinc iron chromite, copper chromite, and combinations thereof.

In some embodiments, the effect pigment is in the form of flakes. In some embodiments, the effect pigment is in the form of thin flakes, for example, “leafing” aluminum flakes. As used herein, the term “thin flake” means that a particle has a ratio of width to thickness (termed aspect ratio) that is in a range of at least 2 to 500, 3 to 400, 10 to 100, 10 to 150, 10 to 200, or 10 to 2000. As such, a “thin flake” particle is one that has a substantially flat structure. In some embodiments, the aspect ratio for the effect pigment, e.g., metallic aluminum pigment flakes, is about 2, about 10, about 20, about 30, about 40, about 50, about 60, about 70, about 80, about 90, about 100, about 110, about 120, about 130, about 140, about 150, about 160, about 170, about 180, about 190, about 200, about 210, about 220, about 230, about 240, about 250, about 260, about 270, about 280, about 290, about 300, about 310, about 320, about 330, about 340, about 350, about 370, about 380, about 390, about 400, about 410, about 420, about 430, about 440, about 450, about 460, about 470, about 480, about 490, about 500, about 510, about 520, about 530, about 540, about 550, about 560, about 570, about 580, about 590, about 600, about 610, about 620, about 630, about 640, about 650, about 660, about 670, about 680, about 690, about 700, about 710, about 720, about 730, about 740, about 750, about 760, about 770, about 780, about 790, about 800, about 810, about 820, about 830, about 840, about 850, about 860, about 870, about 880, about 890, about 900, about 910, about 920, about 930, about 940, about 950, about 960, about 970, about 980, about 990, about 1000, about 1100, about 1200, about 1300, about 1400, about 1500, about 1600, about 1700, about 1800, about 1900, or about 2000. In some embodiment, the aspect ratio for the effect pigment, e.g., metallic aluminum pigment flakes, is about 1, about 2, about 3, about 4, about 5, about 6, about 7, about 8, about 9, about 10, about 11, about 12, about 13, about 14, about 15, about 16, about 17, about 18, about 19, about 20, about 21, about 22, about 23, about 25, about 26, about 27, about 28, about 29, about 30, about 31, about 32, about 33, about 34, about 35, about 40, about 45, about 50, about 55, about 60, about 65, about 70, about 75, about 80, about 85, about 90, about 95, about 100, about 105, about 110, about 115, about 120, about 125, about 130, about 135, about 140, about 145, about 150, about 155, about 160, about 165, about 170, about 175, about 180, about 185, about 190, about 195, about 200, about 205, about 210, about 215, about 220, about 225, about 230, about 235, about 240, about 245, about 250, about 255, about 260, about 265, about 270, about 275, about 280, about 285, about 290, about 295, about 300, about 305, about 310, about 315, about 320, about 325, about 330, about 335, about 340, about 345, about 350, about 355, about 360, about 365, about 370, about 375, about 380, about 390, about 395, or about 400.

In some embodiments, the effect pigment, e.g., metallic aluminum pigment flakes have a thickness in a range of about 0.05 microns to about 10 microns, or from about 0.5 microns to about 5 microns. In some embodiments, the metallic pigment flakes have a thickness value selected from: about 0.05 μm, about 0.1 μm, about 0.2 μm, about 0.3 μm, about 0.4 μm, about 0.5 μm, about 0.6 μm, about 0.7 μm, about 0.8 μm, about 0.9 μm, about 1.0 μm, about 1.1 μm, about 1.2 μm, about 1.3 μm, about 1.4 μm, about 1.5 μm, about 1.6 μm, about 1.7 μm, about 1.8 μm, about 1.9 μm, about 2.0 μm, about 3.0 μm, about 3.5 μm, about 4.0 μm, about 4.5 μm, about 5.0 μm, about 5.5 μm, about 6.0 μm, about 6.5 μm, about 7.0 μm, about 7.5 μm, about 8.0 μm, about 8.5 μm, about 9.0 μm, about 9.5 μm, or about 10.0 μm. In some embodiments, the metallic pigment flakes have a thickness value selected from: about 50 nm, about 55 nm, about 60 nm, about 65 nm, about 70 nm, about 75 nm, about 80 nm, about 85 nm, about 90 nm, about 95 nm, about 100 nm, about 105 nm, about 110 nm, about 115 nm, about 120 nm, about 125 nm, about 130 nm, about 135 nm, about 140 nm, about 145 nm, about 150 nm, about 155 nm, about 160 nm, about 165 nm, about 170 nm, about 175 nm, about 180 nm, about 185 nm, about 190 nm, about 195 nm, about 200 nm, about 205 nm, about 210 nm, about 220 nm, about 225 nm, about 230 nm, about 235 nm, about 240 nm, about 245 nm, about 250 nm, about 255 nm, about 260 nm, about 265 nm, about 270 nm, about 275 nm, about 280 nm, about 285 nm, about 290 nm, about 295 nm, about 300 nm, about 305 nm, about 310 nm, about 315 nm, about 320 nm, about 325 nm, about 330 nm, about 335 nm, about 340 nm, about 345 nm, about 350 nm, about 355 nm, about 360 nm, about 365 nm, about 370 nm, about 375 nm, about 380 nm, about 385 nm, about 390 nm, about 395 nm, about 400 nm, about 405 nm, about 410 nm, about 415 nm, about 420 nm, about 425 nm, about 430 nm, about 435 nm, about 440 nm, about 445 nm, about 450 nm, about 455 nm, about 460 nm, about 465 nm, about 470 nm, about 475 nm, about 480 nm, about 485 nm, about 490 nm, about 495 nm, about 500 nm, about 505 nm, about 510 nm, about 515 nm, about 520 nm, about 525 nm, about 530 nm, about 535 nm, about 540 nm, about 545 nm, about 550 nm, about 555 nm, about 560 nm, about 565 nm, about 570 nm, about 575 nm, about 580 nm, about 585 nm, about 590 nm, about 595 nm, about 600 nm, about 605 nm, about 610 nm, about 615 nm, about 620 nm, about 630 nm, about 635 nm, about 635 nm, about 640 nm, about 645 nm, about 650 nm, about 655 nm, about 660 nm, about 665 nm, about 670 nm, about 675 nm, about 680 nm, about 685 nm, about 690 nm, about 695 nm, about 700 nm, about 705 nm, about 710 nm, about 715 nm, about 720 nm, about 725 nm, about 730 nm, about 735 nm, about 740 nm, about 745 nm, about 750 nm, about 755 nm, about 760 nm, about 765 nm, about 770 nm, about 775 nm, about 780 nm, about 785 nm, about 790 nm, about 795 nm, about 800 nm, about 805 nm, about 810 nm, about 815 nm, about 820 nm, about 825 nm, about 830 nm, about 835 nm, about 840 nm, about 845 nm, about 850 nm, about 855 nm, about 860 nm, about 865 nm, about 870 nm, about 875 nm, about 880 nm, about 885 nm, about 890 nm, about 895 nm, about 900 nm, about 905 nm, about 910 nm, about 915 nm, about 920 nm, about 925 nm, about 930 nm, about 935 nm, about 940 nm, about 945 nm, about 950 nm, about 955 nm, about 960 nm, about 965 nm, about 970 nm, about 975 nm, about 980 nm, about 985 nm, about 990 nm, about 995 nm, about 1000 nm, about 1010 nm, about 1020 nm, about 1030 nm, about 1040 nm, about 1050 nm, about 1060 nm, about 1070 nm, about 1080 nm, about 1090 nm, about 1100 nm, about 1110 nm, about 1120 nm, about 1130 nm, about 1140 nm, about 1150 nm, about 1160 nm, about 1170 nm, about 1180 nm, about 1190 nm, about 1200 nm, about 1250 nm, about 1300 nm, about 1350 nm, about 1400 nm, about 1450 nm, about 1500 nm, about 1550 nm, about 1600 nm, about 1650 nm, about 1700 nm, about 1750 nm, about 1800 nm, about 1850 nm, about 1900 nm, about 1950 nm, about 2000 nm, about 2050 nm, about 2100 nm, about 2150 nm, about 2200 nm, about 2250 nm, about 2300 nm, about 2350 nm, about 2400 nm, about 2450 nm, about 2500 nm, about 2550 nm, about 2600 nm, about 2650 nm, about 2700 nm, about 2750 nm, about 2800 nm, about 2850 nm, about 2900 nm, about 2950 nm, about 3000 nm, about 3050 nm, about 3100 nm, about 3150 nm, about 3200 nm, about 3250 nm, about 3300 nm, about 3350 nm, about 3400 nm, about 3450 nm, about 3500 nm, about 3550 nm, about 3600 nm, about 3650 nm, about 3700 nm, about 3750 nm, about 3800 nm, about 3850 nm, about 3900 nm, about 3950 nm, about 4000 nm, about 4050 nm, about 4100 nm, about 4150 nm, about 4200 nm, about 4250 nm, about 4300 nm, about 4350 nm, about 4400 nm, about 4450 nm, about 4500 nm, about 4550 nm, about 4600 nm, about 4650 nm, about 4700 nm, about 4750 nm, about 4800 nm, about 4850 nm, about 4900 nm, about 4950 nm, about 5000 nm, about 5100 nm, about 5200 nm, about 5300 nm, about 5400 nm, about 5500 nm, about 5600 nm, about 5700 nm, about 5800 nm, about 5900 nm, about 6000 nm, about 6100 nm, about 6200 nm, about 6300 nm, about 6400 nm, about 6500 nm, about 6600 nm, about 6700 nm, about 6800 nm, about 6900 nm, about 7000 nm, about 7100 nm, about 7200 nm, about 7300 nm, about 7400 nm, about 7500 nm, about 7600 nm, about 7700 nm, about 7800 nm, about 7900 nm, about 8000 nm, about 8100 nm, about 8200 nm, about 8300 nm, about 8400 nm, about 8500 nm, about 8600 nm, about 8700 nm, about 8800 nm, about 8900 nm, about 9000 nm, about 9100 nm, about 9200 nm, about 9300 nm, about 9400 nm, about 9500 nm, about 9600 nm, about 9700 nm, about 9800 nm, about 9900 nm, or about 100,000 nm.

In some embodiments, the effect pigment flakes, e.g., metallic aluminum flakes, have a maximum width in a range from 10 μm to 150 μm, or 10 μm to 30 μm. In some embodiments, the effect pigment flakes, e.g., metallic aluminum flakes, have a maximum width selected from 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, or 150 μm. In some embodiments, the effect pigment flakes, e.g., the metallic aluminum flakes have a maximum width selected from 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, or 30 μm. In some embodiments, the thin flake metal or metal alloy particles comprise rounded edges have a maximum width of no more than 25 μm, such as from 10 μm to 15 μm, when measured according to ISO 1524. The use of such thin flake metal or metal alloy particles may provide substantially improved solar reflectance properties for a resulting cool paint, as opposed to the same paint containing larger size particles.

In some embodiments, the effect pigment, e.g., metallic pigment, comprises particles having an average median particle size distribution (D₅₀) in a range from 10 μm to 250 μm. In some embodiments, the average median particle size distribution (D₅₀) is 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, or 100 μm. In some embodiments, the effect pigment, e.g., metallic pigment, comprises particles having an average median particle size distribution (D₅₀) in a range from 50 μm to 60 μm. In some embodiments, the average median particle size distribution (D₅₀) for the metallic pigment particles is 50 μm, 51 μm, 52 μm, 53 μm, 54 μm, 55 μm, 56 μm, 57 μm, 58 μm, 59 μm, or 60 μm.

In some embodiments, the effect pigment can have a paint deposited thereon, such as is the case with silica coated copper flakes, titanium oxide coated mica flakes.

In some embodiments, the effect pigment comprises thin flake particles comprising rounded edges and a smooth and flat surface, as opposed to jagged edges. Flakes having angular edges and uneven surfaces are known in the art as “cornflakes”. In some embodiments, flakes distinguished by more rounded edges, smoother, flatter surfaces are referred to as “silver dollar” flakes.

In some embodiments, the paint composition comprises aluminum particles maximizing optical reflection. In some embodiments, the paint composition comprises aluminum particles with small disc shape exhibiting a mirror finish as effect pigment, which truly gives a mirror finish in visible light. In some embodiments, the cool paint composition comprises aluminum particles with large smooth disc shape as effect pigment, which may enhance or maximize the reflection of solar light. In some embodiments, the cool paint composition comprises “cornflake” shaped large particles, e.g., aluminum particles, as effect pigment.

In some embodiments, the effect pigment is present in the cool paint compositions in an amount of at least 1.0 wt. %, at least 2.0 wt. %, at least 3.0 wt. %, at least 5.0 wt. %, at least 6.0 wt. %, or at least 10.0 wt. % based on the total solids weight of the cool paint composition. In some embodiments, the effect pigment is present in the cool paint compositions in an amount of no more than 50.0 wt. %, no more than 25.0 wt. %, or no more than 15.0 wt. %, based on the total solid weight of the cool paint composition. In some embodiments, the effect pigment is present in the cool paint compositions in an amount greater than 5.0 wt. %, based on the total solid weight of the cool paint composition. In some embodiments, the effect pigment is present in the cool paint compositions in an amount range from about 2.0 wt. % to about 18.0 wt. % by weight, from about 5.0 wt. % to about 15.0 wt. % by weight, or from about 7.0 wt. % to about 13.0 wt. % by weight, based on the total solid weight of the cool paint composition.

In some embodiments, the effect pigment is present in the cool paint compositions in an amount of at least 0.1 wt. %, at least 0.5 wt. %, at least 1.0 wt. %, at least 1.5 wt. %, at least 2.0 wt. %, or at least 2.5 wt. % based on the total weight of the cool paint composition. In some embodiments, the effect pigment is present in the cool paint compositions in an amount of no more than 10.0 wt. %, no more than 7.0 wt. %, or no more than 4.0 wt. %, based on the total weight of the cool paint composition. In some embodiments, the effect pigment is present in the cool paint compositions in an amount range from about 0.1 wt. % to about 10.0 wt. % by weight, from about 0.5 wt. % to about 7.5 wt. % by weight, or from about 1.0 wt. % to about 5.0 wt. % by weight, based on the total weight of the cool paint composition.

In some embodiments, the resulting paint has a total solar reflectance (TSR) of greater than 30%, or greater than 40%, higher than a paint deposited in the same manner from the same composition in which the effect pigment is not present (standard solar irradiance at the earth's surface corrected for atmospheric absorbance).

### 2. IR Transparent Pigment

In some embodiments, the cool paint composition comprises an IR transparent pigment. In some embodiments, the IR transparent pigment absorbs visible radiation but is transparent to near-infrared radiation (i.e., is a visibly absorbing IR transparent pigment).

In some embodiments, the IR transparent pigment has an average transmission of at least 70% in the near-infrared wavelength region. In some embodiments, the IR transparent pigment is also capable of absorbing within the visible light region of the electromagnetic spectrum (400 to 700 nm). Put another way, in some embodiments the IR transparent pigments are color pigments. In some embodiments, the IR transparent color pigment has at least 70%, or at least 80%, of its total absorbance in the visible spectrum in a range from 400 nm to 500 nm. In some embodiments, the IR transparent color pigment has at least 60%, at least 61%, at least 62%, at least 63%, at least 64%, at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 85%, at least 90%, at least 95%, or at least 99% of its total absorbance in the visible spectrum in a range from 500 nm to 600 nm. In some embodiments, the IR transparent color pigment has at least 60% of its total absorbance in the visible spectrum in a range from 600 nm to 700 nm. In some embodiments, the IR transparent color pigment has at least 65% of its total absorbance in the visible spectrum in a range from 600 nm to 700 nm. In some embodiments, the IR transparent color pigment has at least 70% of its total absorbance in the visible spectrum in a range from 600 nm to 700 nm. In some embodiments, the IR transparent color pigment has at least 75% of its total absorbance in the visible spectrum in a range from 600 nm to 700 nm. In some embodiments, the IR transparent color pigment has at least 80% of its total absorbance in the visible spectrum in a range from 600 nm to 700 nm. In some embodiments, the IR transparent color pigment has at least 85% of its total absorbance in the visible spectrum in a range from 600 nm to 700 nm.

In some embodiments, the IR transparent color pigment comprises one or more organic pigments exhibiting dark color (e.g, perylene blacks), or other organic pigments exhibiting color, e.g., phthalocyanine (blues or greens), and carbazole dioxazine (violet). In some embodiments, the total visible absorbance may be at least 70%, or at least 80%, or at least 90% of the total irradiance in the visible region of the spectrum while maintaining a high reflectance of at least 50%, or at least 60% in the near- and shortwave infrared region of the spectrum.

Non-limiting examples of suitable IR transparent pigments include: copper phthalocyanine pigment, halogenated copper phthalocyanine pigment, anthraquinone pigment, quinacridone pigment, perylene pigment, monoazo pigment, disazo pigment, quinophthalone pigment, indanthrone pigment, dioxazine pigment, transparent iron oxide brown pigment, transparent iron oxide red pigment, transparent iron oxide yellow pigment, cadmium orange pigment, ultramarine blue pigment, cadmium yellow pigment, chrome yellow pigment, cobalt aluminate blue pigment, isoindoline pigment, diarylide yellow pigment, brominated anthranthron pigment and the like.

In some embodiments, the cool paint composition comprises an IR transparent color pigment that has a % of reflectance that increases at wavelengths in a range from 750 nm to 850 nm along the electromagnetic spectrum. In some embodiments, the cool paint composition comprises a visibly absorbing IR transparent pigment that has a % of reflectance that ranges from at least 10% at a wavelength of 750 nm along the electromagnetic spectrum to at least 50% at a wavelength of 900 nm.

In some embodiments, the cool paint compositions comprise at least one IR transparent black pigment having the perylene chromophore of formula (I)

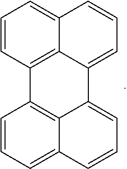 [SMILES: c1cc2cccc3c4cccc5cccc(c(c1)c23)c54]

In some embodiments, the cool paint compositions comprise two or more IR transparent black pigments having the perylene chromophore of formula (I).

Some of the commercially available of the perylene type black pigments sold under various trademarks include, Lumogen® Black FK 4280 pigment sold by BASF (Formula II and III below), Paliogen® Black L0086 (formula IV below), sold by BASF, which has a Color Index of “Pigment Black 32” (Part 1) and “71133” (Part 2), as well as Paliogen® Black 50084 sold by BASF (Formula V below), which has Color Index of “Pigment Black 31” (Part 1) and “71132” (Part 2).

In some embodiments, the cool paint composition comprises a perylene pigment according to formulae (II) or (III):

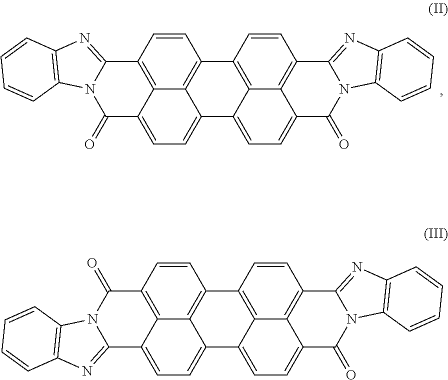 [SMILES: O=c1c2ccc3c4ccc5c(=O)n6c7ccccc7nc6c6ccc(c7ccc(c2c37)c2nc3ccccc3n12)c4c56 ; O=c1c2ccc3c4ccc5c6c(ccc(c7ccc(c2c37)c2nc3ccccc3n12)c46)c(=O)n1c2ccccc2nc51]

Such pigments are commercially available as Paliogen® Black EH 0788 and Lumogen® Black FK4280 from BASF.

In certain embodiments, the cool paint composition also comprises a perylene pigment according to formula (IV):

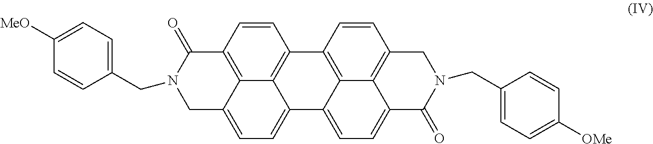 [SMILES: COc1ccc(CN2Cc3ccc4c5ccc6c7c(ccc(c8ccc(c3c48)C2=O)c75)CN(Cc2ccc(OC)cc2)C6=O)cc1]

Such perylene pigment is also known as “CI Pigment Black 32” and is commercially available as Paliogen® Black L 0086 from BASF.

In certain embodiments, the cool paint composition also comprises a perylene pigment according to formula (V):

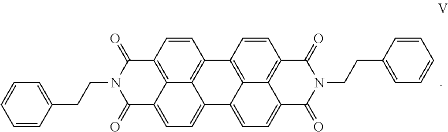 [SMILES: O=C1c2ccc3c4ccc5c6c(ccc(c7ccc(c2c37)C(=O)N1CCc1ccccc1)c64)C(=O)N(CCc1ccccc1)C5=O]

Such perylene pigment is commercially available as Paliogen® Black 50084 sold by BASF.

In some embodiments, an IR transparent pigment, such as the perylene-based pigments can be chemically adsorbed on the surface of the effect pigment, to provide a dark, sometimes black color effect pigment comprising reflective metallic pigment core.

In some embodiments, the IR transparent pigment is present in the cool paint compositions in an amount ranging from about 3.0 wt. % to about 95 wt. %, from about 5.0 wt. % to about 50.0 wt. %, from about 5.0 wt. % to about 25.0 wt. %, from about 10.0 wt. % to about 20.0 wt. %, based on the total solids weight of the cool paint composition. In some embodiments, the IR transparent pigment is present in the cool paint composition in an amount of no more than 50 wt. %, no more than 25.0 wt. %, or no more than 15.0 wt. %, based on the total solid weight of the cool paint composition. In some embodiments, the effect pigment is presented in an amount selected from: about 2.0 wt. %, about 3.0 wt. %, about 4.0 wt. %, about 5.0 wt. %, about 10.0 wt. %, about 15.0 wt. %, about 20.0 wt. %, about 25.0 wt. %, about 30.0 wt. %, about 35.0 wt. %, about 40.0 wt. %, about 45.0 wt. %, about 50.0 wt. %, about 55.0 wt. %, about 60.0 wt. %, about 65.0 wt. %, about 70 wt. %, about 75.0 wt. %, about 80.0 wt. %, about 85.0 wt. %, about 90.0 wt. %, about 95.0 wt. %, about 96.0 wt. %, about 97.0 wt. %, or about 98.0 wt. % by the total solid weight of the cool paint composition. In some embodiments, the effect pigment is present in the cool paint compositions present in an amount ranging from about 1.0 wt. % to about 15.0 wt. %, from about 3.0 wt. % to about 15.0 wt. %, or from about 3.0 wt. % to about 10.0 wt. %, based on the total weight of the cool paint composition.

In some embodiments, the cool paint composition disclosed herein exhibits a total solar reflectance (TSR) of at least 20%, at least 25%, at least 30%, at least 35%, at least 40%, at least 45%, or at least 50%. In some embodiments, the cool paint composition exhibits a total solar reflectance (TSR) in a range from 20% to 80%. In some embodiments, the cool paint composition exhibits a total solar reflectance (TSR) in a range from 25% to 55%. In some embodiments, cool paint composition formed on the substrate exhibits a total solar reflectance (TSR) value selected from 20%, 25%, 30%, 35%, 40%, 45%, 50%, 55%, 60%, 65%, 70%, 75%, or 80%.

In some embodiments, the cool paint composition containing the crosslinked fluorocarbon polymer binder exhibits excellent weathering properties, e.g. the cool paint maintains at least 80% gloss upon exposure to QUV-A at 60° C. for 15,000 hours. In some embodiments, the cool paint composition containing the crosslinked fluorocarbon polymer binder exhibits excellent weathering properties (e.g. no significant surface cracks, at least 80% gloss retention) as determined by the field environmental exposure tests in Florida for two years with no degradation. In some embodiments, the cool paint composition exhibits excellent weatherability measured by 90% percent gloss retention exposing the paint to QUV-A at 60° C. for 15,000 hours.

In some embodiments, substrate materials that can be coated with the cool paint of the present disclosure include, but are not limited to: glasses, ceramics, plastics, smooth-surfaced composites and metallic substrates. In some embodiments, the cool paint coated substrate may include metallic substrates or plastic substrates. In some embodiments, the cool paint comprises a perylene IR transparent pigment and the substrate is a metallic substrate. In some embodiments, the cool paint comprises a perylene IR transparent pigment and the substrate is a roof or roofing material.

C. Additives

In some embodiments, the cool paint composition may further comprise an additive. In some embodiments, the additive may be one or more of polyacrylate leveling agent, surfactants, dispersants, waxes, fillers, defoamers, antidust agents, extenders, preservatives, dryness retarders, rheology control additives, wetting agents, antioxidants, UV absorbers, light stabilizers, co-solvent, plasticizer, catalyst, rheology modifier, or combinations thereof. In some embodiments, the additive is a polyacrylate leveling agent. In some embodiments, the additive may be present in an amount ranging from 0 wt. % to about 20.0 wt. %, preferably from 0 wt. % to about 10.0 wt. % based on the total weight of the cool paint composition.

### II. Paint Systems for Solar Heat Management

In some embodiments, a cool paint composition has a one-layer structure having the pigment system (e.g., effects pigment and the IR transparent pigment) admixed with the polymer binder system (e.g., crosslinked fluorocarbon copolymer binder). In some embodiments, a cool paint comprises a paint system has a multiple layer structure comprising a top layer and a bottom layer. In some embodiments, the IR transparent pigment of the pigment system is in the top layer comprising a low refractive index polymer matrix placed over a highly reflective bottom layer containing the metallic aluminum pigment flakes as effect pigments. In some embodiments, such a multiple layer structure may be more efficient for thermal reflection. In some embodiments, the cool paint composition does not have the scattering associated with an IR reflective pigment in the top layer, but allowing the IR light to pass through the top layer to the more efficiently reflective metallic aluminum pigment flakes in the bottom layer. In some embodiments, the metallic aluminum pigment flakes layer in a fluorocarbon polymer matrix has large flat plates to maximize reflection.

In one embodiment, this disclosure provides a paint system for reflecting solar thermal energy comprising: a base paint comprising: an epoxy or acrylic polymer; and an effect pigment; a topcoat paint comprising: a fluorocarbon polymer; and an IR transparent pigment, wherein the effect pigment has a % reflectance that ranges from at least 10% at a wavelength of 750 nm to at least 50% at a wavelength of 900 nm, and wherein the IR transparent pigment has an average transmission of at least 65% in the near infrared wavelength region (700 nm-2600 nm).

In some embodiments, the fluorocarbon polymer is a crosslinkable prepolymer having plurality of reactive hydroxyl groups comprises an alternating copolymer comprising fluoroethylene and hydroxyl alkyl vinyl ether repeating units and an aliphatic polyisocyanate crosslinker.

In some embodiments, the aliphatic polyisocyanate crosslinker is an oligomer or polymer of hexamethylene diisocyanate. In some embodiments, the fluorocarbon polymer is a crosslinked fluoropolyurethane. In some embodiments, the crosslinked fluoropolyurethane comprises crosslinkers resulting from isocyanate (NCO). In some embodiments, the crosslinked fluoropolyurethane comprises a isocyanate crosslinker. In some embodiments, the crosslinked fluoropolyurethane comprises a reaction product of a fluoroethylene vinyl ether polyol with an aliphatic polyisocyanate. In some embodiments, the fluoroethylene vinyl ether polyol is an alternating copolymer comprising fluoroethylene and hydroxy alkyl vinyl ether as repeating units. In some embodiments, the aliphatic polyisocyanate is hexamethylene diisocyanate. In some embodiments, the fluoroethylene vinyl ether polyol has a hydroxyl value (OH number) in a range from about 10 mg KOH/g-polymer to about 200 mg KOH/g-polymer. In some embodiments, the fluoroethylene vinyl ether polyol has a hydroxyl value (OH number) of about 100 mg KOH/g-polymer.

In some embodiments, the effect pigment in the paint system comprises metallic aluminum pigment flakes. In some embodiments, the metallic aluminum pigment flakes are in the form of thin flakes (substantially flat structure).

In some embodiments, the metallic aluminum pigment flakes have a thickness range value range selected from: 0.05 μm to 10 μm, or 0.5 μm to 5 μm. In some embodiments, the metallic aluminum pigment flakes have a maximum width in a range selected from 10 μm to 30 μm, or 10 μm to 150 μm. In some embodiments, the metal aluminum flakes have a ratio of width to thickness of those in a range selected from: 2 μm, 3 μm to 400 μm, 10 μm to 2000 μm, 10 μm to 200 μm, or 10 μm to 150 μm. In some embodiments, the metal aluminum flakes have cornflake shape (angular edges and uneven surface), silver dollar shape (rounded edges, smoother, flatter surface), or disc shape. In some embodiments, the effect pigment comprises metallic pigment particles having an average median particle size distribution (D₅₀) in a range from 50 μm to 60 μm. In some embodiments, the effect pigment comprises a silicate coated metallic aluminum pigment.

In some embodiments, the IR transparent pigment in the paint system is colored. In some embodiments, the IR transparent pigment exhibits black. IR transparent pigment the IR transparent pigment comprises perylene black (Color Index Number 71133; Color Index Name perylene black 32). In some embodiments, the paint system is exclusive of titanium dioxide and barium sulfate.

In some embodiments, the paint system has a total solar reflectance (TSR) of greater than 30%, or greater than 40% (standard solar irradiance at the earth's surface corrected for atmospheric absorbance). In some embodiments, the paint system exhibits excellent weatherability measured by 80% percent gloss retention exposing the paint to QUV-A at 60° C. for 15,000 hours. In some embodiments, the paint composition exhibits excellent weatherability measured by 90% percent gloss retention exposing the paint to QUV-A at 60° C. for 15,000 hours.

### III. Methods of the Present Invention

In some embodiments, this disclosure provides a method for reducing solar heat load by reflecting solar energy comprising: applying a paint to a substrate, wherein the paint comprises: a fluorocarbon prepolymer and a crosslinker; an effect pigment; and an IR transparent pigment; curing the paint to form crosslinking in the fluorocarbon polymer.

In some embodiments, this disclosure provides a method for reducing solar heat load by reflecting solar energy comprising: applying a base paint comprising a fluorocarbon prepolymer and a crosslinker and an effect pigment to a substrate; curing the base paint to form crosslinked fluorocarbon polymer; applying a topcoat paint comprising an IR transparent pigment to the base paint; exposing the substrate to weathering conditions.

In some embodiments, this disclosure provides a process for coating the surface of a substrate, the process comprises the steps of (i) applying a cool paint composition comprising a fluorocarbon polymer binder, at least one effect pigment, at one IR transparent organic pigment, at least one crosslinker; (ii) optionally removing solvent, and (iii) forming a cool paint coated onto the substrate. In some embodiments, the cool paint formed on the substrate may have a thickness in a range from about 30 μm to about 200 μm, from about 30 μm to about 100 μm, or from about 30 μm to about 60 μm. In some embodiments, the cool paint formed on the substrate may have a thickness value selected from: about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, about 155 μm, about 160 μm, about 165 μm, about 170 μm, about 175 μm, about 180 μm, about 185 μm, about 190 μm, about 195 μm, or about 200 μm.

### III. Coated Article

In an embodiment, this disclosure provides for an article including a substrate and a coating described herein.

The substrate may be flexible or rigid. In some embodiments the substrate may comprise a flexible material such as plastic or rubber. In particular, thermoplastic polyolefin (TPO) and ethylene propylene diene monomer (EPDM) rubber are commonly used as roofing membranes, and it is desirable to provide such materials that are pre-coated before application to a roof. The coatings may be applied directly to the flexible substrate, or the substrate may first be coated with an appropriate primer to promote adhesion. In some embodiments the substrate may comprise any metal, and in particular any structural metal, such as aluminum or steel. In some embodiments the substrate may comprise polyvinyl chloride (PVC).

In some areas where grass and other natural ground cover is inconvenient or difficult to maintain, ground may be covered with stones and/or rock. These areas are susceptible to “heat island” effects due to absorption of sunlight by these stone and/or rock materials and the subsequent release of this absorbed energy as heat. The solar absorption responsible for this effect can be mitigated by coating these stone and/or rock materials with the inventive coating prior to their distribution on the ground. Examples of suitable stone and/or rock include, but are not limited to granite, lava rock, river rock, flagstone, brick, and marble.

The inventive coatings can be applied by typical methods of paint application, including brushing, rolling, and spraying. Coatings may be applied to a wide range of substrates, including but not limited to roofs, walls, decks, and other architectural areas. Coatings may also be applied to non-architectural substrates, such as vehicles, containers, boats, and other substrates for which either surface or interior temperature reduction during exposure to solar illumination is desired.

In some embodiments, the article comprises a thin coating. For example, a coating may have a thickness of about 0.02 in. or less, 0.015 in. or less, 0.01 in. or less, about 0.008 in. or less, about 0.006 in. or less, about 0.004 in. or less, or about 0.002 in. or less. In some embodiments a coating may have a thickness in a range of from about 0.0005 in. to about 0.01 in., from about 0.001 in. to about 0.01 in., from about 0.001 in. to about 0.008 in., from about 0.001 in. to about 0.006 in., from about 0.001 in. to about 0.004 in., or from about 0.001 in. to about 0.003 in. In some embodiments, the coating may have a thickness in a range from about 30 μm to about 200 μm, from about 30 μm to about 100 μm, or from about 30 μm to about 60 μm. In some embodiments, the coating may have a thickness of about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, about 155 μm, about 160 μm, about 165 μm, about 170 μm, about 175 μm, about 180 μm, about 185 μm, about 190 μm, about 195 μm, or about 200 μm.

In some embodiments, a substrate may be coated and then later installed in an application of use. For example, a coating may be applied to a metal sheeting in a factory to form an article and the article later installed as a pre-coated roofing component. Prior art articles comprising a substrate coated with a polyvinylidine fluoride (PVDF, tradename KYNAR) are subject to scratching and marring, and are not easily repaired by any recoating method because paints do not adhere easily, if at all, to polyvinylidine fluoride. In contrast, articles of the present invention comprising coatings of the present invention are resistant to such damage, and are also easily touched up with fresh coating if damage should occur. Moreover, in some embodiments the coating is fully, or substantially fully, crosslinked, resulting in a coating that is tougher and more resistant to solvents than prior art polyvinylidene fluoride coatings. It can also be repaired easily with a paint comprised of the same materials.

### EXAMPLES

The embodiments encompassed herein are now described with reference to the following examples. These examples are provided for the purpose of illustration only and the disclosure encompassed herein should in no way be construed as being limited to these examples, but rather should be construed to encompass any and all variations which become evident as a result of the teachings provided herein.

### Example 1. Heat Build-Up Properties for the Cool Paint in the Topcoat of Two-Layer Roof Paint System

Four 1-gallon cans were primed with Hentzen tan epoxy primer on the surface. The cans were coated with topcoats as the following:

Primer Formulation: Hentzen® tan epoxy primer formulation comprising barium sulfate, bisphenol A/epichlorohydrin-based epoxy resin, methyl amyl ketone, methyl isobutyl ketone, xylene

Can #1: primer only; no topcoat

Can #2: Henry® aluminized fiber roof paint comprising asphalt, aluminum paste, moisture scavenger, fillers and hydrocarbon solvents (Commercial cool roof paint formulation)

Can #3: Commercial matte black paint painted over primer.

Can #4: Inventive cool paint formulation comprising Lumiflon® 916F, Paliogen® Black L0086, Pergopak® M3, Desmodur® N3300, K-kat® 4205, methyl acetate, and ethyl 3-propiophenone, painted over a base layer comprising Lumiflon® 916F, Stapa® Hydrolan BG 212, Desmodur® N3300, K-kat® 4205, methyl acetate, and ethyl 3-propiophenone, painted over primer.

Holes were drilled in the top of each can to allow a thermometer to be centered in the can. All cans were laid on their side, spaced two feet apart, at noon under direct sun.

Outside temperature was 84° F. The temperature reached for the cans having different topcoat systems are summarized in Table 1 below.

TABLE 1
Heat Build-Up Test Results

| Can number | Temperature Reached ° F.¹ |
|---|---|
| 1 (Comparative) | 98 |
| 2 (Comparative) | 94 |
| 3 (Comparative) | 115 |
| 4 (Inventive cool paint) | 87 |

¹Interior temperatures in the cans reached after two hours of sun exposure.

Even though the inventive cool paint exhibited black color, it achieved the lowest temperature as compared with various comparative top paint system under the same sun exposure condition.

### Example 2. Single Layer Roof Paint

Each formulation was spray painted onto a 6″×6″×0.025″ aluminum plate coated with a tan epoxy primer and allowed to cure for 5 days. Similarly, reference samples were prepared with conventional black and white paints coated on similarly primed aluminum plates. Reflectance spectra of each paint were measured on a Shimadzu 2600 spectrophotometer over the wavelength range 300-2600 nm.

Each sample was placed on a wooden box and exposed to light from a ceramic thermal (IR) lamp. Temperature of the surfaces and of the interior of the box were monitored with a K-type thermocouple connected to a wireless monitor, with data captured every minute.

Paint Formulation 18E18-700

| | weight amount |
|---|---|
| Components | (weight parts) |
| Lumiflon ® 916F | 55.5 |
| Paliogen ® Black L0086 | 25.4 |
| Hydrolan ® BG212, | 55.8 |
| 63.4% dispersion of | |
| aluminum pigment in | |
| 2-propanol | |
| Desmodur ® N3300 | 19.6 |
| K-kat ® 4205 | 3.03 |
| BYK ® 356 | 0.99 |
| Methyl Acetate | 213.5 |
| Ethyl 3-ethoxypropionate | 26.0 |

Paint Formulation 18E18-701

| | weight amount |
|---|---|
| Components | (weight parts) |
| Lumiflon ® 916F | 55.5 |
| Paliogen ® Black EH0788 | 25.4 |
| Hydrolan ® BG212 | 55.8 |
| Desmodur ® N3300 | 19.6 |
| K-kat ® 4205 | 3.03 |
| BYK ® 356 | 0.99 |
| Methyl Acetate | 213.5 |
| Ethyl 3-ethoxypropionate | 26.0 |

Paint Formulation 18E18-702

| | weight amount |
|---|---|
| Components | (weight parts) |
| Lumiflon ® 916F | 55.5 |
| Paliogen ® Black L0086 | 12.7 |
| Paliogen ® Black EH0788 | 12.7 |
| Hydrolan ® BG212 | 55.8 |
| Desmodur ® N3300 | 19.6 |
| K-kat ® 4205 | 3.03 |
| BYK ® 356 | 0.99 |
| Methyl Acetate | 213.5 |
| Ethyl 3-ethoxypropionate | 26.0 |

Lumiflon® LF 916F: sold by AGC Chemicals Inc., Exton, Pa., trifluorochloroethylene/4-hydroxybutyl vinyl ether/ethyl vinyl ether/cyclohexyl vinyl ether copolymer, softening point 117.5° C., glass transition temperature (Tg) 34° C., hydroxyl value 100 mg KOH/g-polymer, number average molecular weight Mn=7,000 Da.

Paliogen® Black L0086: perylene pigment sold by BASF.

Paliogen® Black EH0788: perylene pigment sold by BASF.

Hydrolan® BG212: 63.4% aluminium pigment dispersion in 2-propanol, aluminium pigment pastes have been encapsulated by a transparent and homogeneous layer of silicate.

Desmodur® N3300: a hexamethylene diisocyanate-derived isocyanurate trimer sold by Covestro.

K-kat® 4205: zirconium complex based crosslinking catalyst, sold by King Industries.

BYK® 356: an acrylic leveling additive for solvent-borne and solvent-free systems.

Each of the paint formulations 18E18-700, 18E18-701 and 18E18-702 was coated on a 25 mil aluminum plate and cured for 5 days. Reflectance spectra of each paint were captured on a Shimadzu 2600 spectrophotometer over the wavelength range 300-2600 nm.

Solar reflectance (SR) was calculated from the cumulative reflected power as a fraction of the cumulative incident power:

$$SR = \frac{( {\int }_{λ} {R}_{s , λ} {I}_{λ} )}{{\int }_{λ} {I}_{λ}}$$

The calculated solar reflectance values based on the reflectance spectra of each cool paint tested are summarized in Table 2.

TABLE 2
Solar Reflectance Test Results
for Single Layer Roof Paint

| | Solar reflectance |
|---|---|
| Formulation | (calculated) |
| 18E18-700 | 0.336 |
| 18E18-701 | 0.386 |
| 18E18-702 | 0.357 |

1. A paint for reflecting solar thermal energy comprising:
a fluorocarbon polymer;
an effect pigment; and
an IR transparent pigment,
wherein the effect pigment has a % reflectance that ranges from at least 10% at a wavelength of 750 nm to at least 50% at a wavelength of 900 nm, and
wherein the IR transparent pigment has an average transmission of at least 65% in the near infrared wavelength region (700 nm-2600 nm).

2. The paint according to claim 1, wherein the fluorocarbon polymer is a prepolymer comprising an alternating copolymer having fluoroethylene and hydroxyl alkyl vinyl ether repeating units or a crosslinked fluoropolyurethane.

3. The paint according to claim 2, further comprising an aliphatic polyisocyanate crosslinker.

4-5. (canceled)

6. The paint according to claim 2, wherein the crosslinked fluoropolyurethane comprises cross linkers derived from diisocyanate or a reaction product of a fluoroethylene vinyl ether polyol with an aliphatic polyisocyanate.

7. (canceled)

8. The paint according to claim 6, wherein the fluoroethylene vinyl ether polyol comprises an alternating copolymer having fluoroethylene and hydroxy alkyl vinyl ether as repeating units, or wherein the fluoroethylene vinyl ether polyol has a hydroxyl value (OH number) in a range from about 10 mg KOH/g-polymer to about 200 mg KOH/g-polymer.

9. The paint according to claim 6, wherein the aliphatic polyisocyanate is an oligomer or polymer of hexamethylene diisocyanate.

10-11. (canceled)

12. The paint according to claim 1, wherein the effect pigment comprises metallic aluminum pigment flakes.

13. The paint according to claim 12, where the metallic aluminum pigment flakes are in the form of thin flakes having a substantially flat structure or a structure having a cornflake shape (angular edges and uneven surface), a silver dollar shape (rounded edges, smoother, fatter surface), or a disc shape.

14-15. (canceled)

16. The paint according to claim 13, where the metallic aluminum pigment flakes have a ratio of width to thickness in a range selected from 2, 3 to 400, 10 to 2000, 10 to 200, or 10 to 150.

17. (canceled)

18. The paint according to claim 1, wherein the effect pigment comprises metallic pigment particles having an average median particle size distribution (D₅₀) in a range from 50 μm to 60 μm.

19. The paint according to claim 1, wherein the effect pigment comprises a silicate coated metallic aluminum pigment.

20-21. (canceled)

22. The paint according to claim 1, wherein the IR transparent pigment comprises perylene black (Color Index Number 71133; Color Index Name perylene black 32).

23. The paint according to claim 1, wherein the IR transparent pigment comprises one or more of copper phthalocyanine pigment, halogenated copper phthalocyanine pigment, anthraquinone pigment, quinacridone pigment, perylene pigment, monoazo pigment, disazo pigment, quinophthalone pigment, indanthrone pigment, dioxazine pigment, transparent iron oxide brown pigment, transparent iron oxide red pigment, transparent iron oxide yellow pigment, cadmium orange pigment, ultramarine blue pigment, cadmium yellow pigment, chrome yellow pigment, cobalt aluminate blue pigment, isoindoline pigment, diarylide yellow pigment, and brominated anthranthron pigment.

24. The paint according to claim 1, wherein the paint is exclusive of titanium dioxide and barium sulfate.

25. The paint according to claim 1, wherein the paint has a total solar reflectance (TSR) of greater than 30%, or greater than 40% (standard solar irradiance at the earth's surface corrected for atmospheric absorbance).

26. The paint according to claim 1, wherein the paint maintains at least 80% gloss retention upon exposure to QUV-A at 60° C. for 15,000 hours.

27-51. (canceled)

52. A method for reflecting solar thermal energy comprising:
applying a paint to a substrate, wherein the paint comprises:
a fluorocarbon prepolymer having plurality of hydroxyl groups;
a diisocyanate crosslinker;
an effect pigment; and
an IR transparent pigment;
curing the paint to form crosslinked fluorocarbon polymer; and
exposing the substrate to weathering conditions.

53. (canceled)

54. An article comprising a substrate and a coating,
wherein the coating is adhered to at least a portion of a surface of the substrate, and
wherein the coating comprises:
a fluorocarbon polymer;
an effect pigment having a % reflectance that ranges from at least 10% at a wavelength of 750 nm to at least 50% at a wavelength of 900 nm; and
an IR transparent pigment having an average transmission of at least 65% in the near infrared wavelength region (700 nm-2600 nm).

55. The article of claim 54, wherein the substrate is flexible.

56. The article of claim 54, wherein the substrate is rigid.

57. The article of claim 54, wherein the substrate comprises plastic.

58. The article of claim 54, wherein the substrate comprises one or more of stone, rock, brick, and ceramic.

59. The article of claim 54, wherein the substrate comprises metal.

60. The article of claim 54, wherein the substrate comprises a surface, wherein the surface has been pre-treated.

61. (canceled)

62. The article of claim 54, wherein the substrate has been treated to promote adhesion.
